(19) United States
(12) Patent Application Publication
(10) Pub. No.: US 2023/0126424 A1
(43) Pub. Date: Apr. 27, 2023

(54) DEVICE LOCATION DETERMINATIONS

(71) Applicant: Hewlett-Packard Development Company, L.P., Spring, TX (US)

(72) Inventors: Isaac Lagnado, Spring, TX (US); Chih-Hung Chien, Taipei City (TW); Danny Farnyih Meng, Spring, TX (US); Steven Petit, Spring, TX (US); Mats Anders Krister Luckman, Spring, TX (US)

(21) Appl. No.: 17/510,845

(22) Filed: Oct. 26, 2021

(51) Int. Cl. H04W 4/029; G01S 19/48

(52) U.S. Cl. CPC H04W 4/029; G01S 19/48

(57) ABSTRACT

In some examples, the disclosure describes a device that includes a radio device and a processor to: instruct the radio device to perform a radio scan of an area, compare the radio scan to a previous radio scan by the radio device, determine that the device has moved from a first location to a second location based on the comparison, and execute a global positioning system (GPS) request to identify the second location.

### BACKGROUND

Computing devices are utilized to perform particular functions. In some examples, computing devices utilize battery power that is limited when the computing device is not connected to an electrical power source. In some examples, computing devices are mobile computing devices that are carriable or moveable from a first location to a second location.

### BRIEF DESCRIPTION OF THE DRAWINGS

FIG. 1 illustrates an example of a method for determining device locations.

FIG. 2 illustrates an example of a computing device for determining device locations.

FIG. 3 illustrates an example of a memory resource for determining device locations.

FIG. 4 illustrates an example of a system for determining device locations.

### DETAILED DESCRIPTION

A user may utilize a computing device for various purposes, such as for business and/or recreational use. As used herein, the term computing device refers to an electronic device having a processor and a memory resource. Examples of computing devices include, for instance, a laptop computer, a notebook computer, a desktop computer, and/or a mobile device (e.g., a smart phone, tablet, personal digital assistant, smart glasses, a wrist-worn device, etc.), among other types of computing devices.

Computing devices that are mobile devices may utilize different settings and/or perform different functions when at different locations. For example, a first location may include a secure wireless connection and a second location may include a non-secure or public wireless connection. In this example, the computing device may have a first set of restrictions or permissions within the first location and a second set of restrictions or permissions in the second location.

In some examples, a computing device is utilized as an Internet of things (IoT) device. As used herein, an IoT device includes a device within a system of interrelated, internet-connected devices that are able to collect and transfer data over a network without human intervention. In some examples, the computing device may have a user associated with the computing device and utilized by a user during a user mode. In these examples, the computing device can be altered from the user mode to an IoT mode where the computing device operates as an IoT device within an IoT system to transmit data and/or receive data. In other examples, the user may utilize the computing device within user mode while the device is also operating as an IoT device.

In some examples, the computing device may have different restrictions based on a current location of the computing device. As described herein, different locations have different types of network connections (e.g., secure, public, etc.). In some examples, the computing device may perform particular functions in the IoT mode when the computing device is in a first location and perform other functions in the IoT mode when the computing device is in a second location.

Thus, determining the location of the computing device when the computing device is in an IoT mode can be utilized to determine a mode of the computing device. In other cases, determining the location of the computing device (e.g., tracking a location of the computing device) may be useful for the owner and/or management of the device. In this way, determining the location of a computing device is performed at particular time periods. However, determining the location of the computing device is time consuming, process intensive, and/or power use intensive. With limited resources provided to computing devices, determining the location of the computing device may be cost prohibitive under certain circumstances.

The present disclosure relates to device location determinations. In some examples, the device location determinations are performed to save computing resources and/or electrical resources of the computing device while providing an updated location determination for the computing device. In this way, remote computing devices utilize current location information of the computing device. In some examples, the computing device utilizes a radio device to perform a scan and compares the scan data to previous scan data to determine whether the computing device has moved since a last location determination. When the scan data comparison reveals the same devices or similar devices are within the scan area, it is determined that the computing device is in the same location as the previous location determination. In this way, a more in-depth location determination (e.g., GPS request, location calculation, etc.) is not performed, which saves computing resources. In addition, the IoT mode may utilize cellular communications and may have to pay for interactions based on a physical location of the computing device.

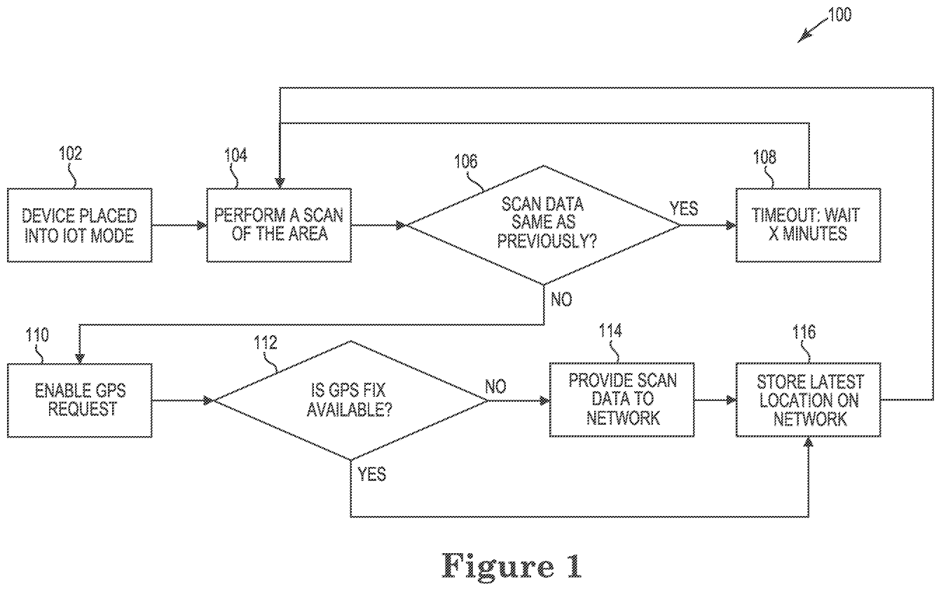

FIG. 1 illustrates an example of a method 100 for determining device locations. In some examples, the method 100 illustrates instructions that are stored on a memory resource and executed by a processor. For example, the method 100 is executable by a computing device or computing system. In some examples, the method 100 is executed by a computing device that utilizes a user mode and an IoT mode. As described herein, the user mode allows the computing device to receive inputs from a user and provide outputs to the user. However, in the IoT mode, the computing device is able to collect data and provide data to an IoT network without the instruction or input from the user.

In some examples, the method 100 starts by determining when the device is in an IoT mode at 102. In some examples, the device (e.g., computing device, etc.) is placed into the IoT mode through a user input. In other examples, the device is altered from the user mode to the IoT mode based on a state of the device. For example, the device may be in a low power state or determine that a human user is not utilizing the device for a period of time. In this way, the device determines that the device is to be placed into the IoT mode.

In some examples, the computing resources of the computing device are limited in both the user mode and the IoT mode. However, the resources within the IoT mode may be even more limited than the user mode since the user of the device may not be aware that resources are being utilized during the IoT mode and may want to utilize the resources when they return to the device. For example, the device may be a mobile device that operates on battery power. In this example, the battery power is limited to a particular amount when the device is away from a power source. In this example, a user of the device may want to utilize the battery resources of the device when the user returns to the device to utilize the device in the user mode. For this reason, utilizing a relatively large amount of battery resources may not be a positive experience for the user of the device. In these examples, limiting the quantity of battery power and/or other computing resources during the IoT mode may increase a positive user experience of the device.

In some examples, the method 100 includes performing a scan at 104. In some examples, performing a scan includes instructing a radio device to perform an area scan of wireless devices within the area. In some examples, the scan is utilized to determine a list of cellular identifications of devices and/or wireless towers within the area. In some examples, the cellular identifications are names or identifications of the device that is viewable or accessed in response to a message (e.g., ping, etc.). That is, the scan includes a broadcast ping that is sent to devices within the area and the devices respond to the broadcast ping with a corresponding identification. In this way, the scan provides a scan list of a plurality of devices within the area that received the broadcast ping and responded to the broadcast ping with a corresponding identification.

In some examples, the list of device identifications is stored with a determined location of the device. In this way, the list of device identifications is compared to a previous list of device identifications. In some examples, a determination that the device is in the same location as a previous location determination when a current list of device identifications is the same or includes a particular quantity of the same device identifications. In other examples, a determination that the device is in a different location is made when the list of device identifications are different or a particular quantity of device identifications are different than a previous list of device identifications.

In some examples, the scan performed at 104 identifies a signal strength of the radio device. For example, the signal strength is represented by a received signal strength indictor (RSSI). As used herein, the RSSI is a measurement of a connection between the device or radio device and an access point (AP) or router. In some examples, the signal strength between the device and a particular access point is compared to a previous determined signal strength between the device and the particular access point. For example, a previous signal strength is compared to a current signal strength to determine if the device has moved from a previously determined location.

In some examples, the scan performed at 104 identifies a service set identifier (SSID) for a plurality of devices connected to a local area network (LAN) or wide local area network (WLAN). As used herein, the SSID is a name assigned to a device within a particular network and/or a name assigned to the network. In these examples, the SSID is utilized to identify each of the devices connected to a particular network. In some examples, the list of SSIDs for the plurality of devices is a list of devices that are relatively close to the device that have received a ping or message signal from the device during the scan at 104 and responded with a corresponding SSID of the plurality of devices. In some examples, the list of SSIDs is utilized to determine whether the device has changed locations based on a comparison between a previous list of SSIDs and a current list of SSIDs. In yet more examples, a single SSID identifier may be utilized by a number of different network devices, and so a specific location may also be indicated by the actual unique identifier (MAC address) of the access point, beyond just the SSID itself.

As described herein, the scan performed at 104 includes scan data such as cellular device identifications, signal strength information, and/or SSIDs from a LAN or WLAN. Although these specific examples, are described, other types of cellular and/or network data can be collected from the scan performed at 104. In some examples, the additional data or properties of the scan at 104 are utilized to determine if changes in the environment of the device has changed to indicate that the device has moved to a different location.

The method 100 includes determining if the scan data is the same as a previous set of scan data at 106. As described herein, the scan data (e.g., cellular device identification, RSSI, SSID, etc.) from a previous scan is compared to the scan data from the scan at 104 to determine if there was a change. In some examples, a determination that the device has moved is made when a threshold percentage or threshold quantity of differences occur between the previous scan data and the current scan data. Similarly, a determination that the device has not moved or stayed in a relatively similar location is made when a threshold percentage or threshold quantity of similarities occur between the previous scan data and the current scan data.

The method moves to start a timer at 108 when the scan data of a previous scan is the same as the scan data from the scan at 104. The timer is utilized to identify when a particular quantity of time has passed from the scan performed at 104 and when an additional scan is to be performed at 104. The timer or quantity of time is based on a number of factors. For example, a relatively longer period of time is utilized when it would take a greater distance of change to result in a different mode or different set of settings to be utilized by the device. In other examples, a relatively shorter period of is utilized when a mode or settings of the device is going to be change when the device is moved a relatively short distance. That is, the quantity of time can depend on a quantity of time it would take to move the device from a first area that corresponds to a first mode or set of settings to a second area that corresponds to a second mode or set of settings.

When the scan data is different from the scan data of a previous scan, the method 100 can enable a global positioning system (GPS) request at 110. In some examples, enabling a GPS request includes activating a GPS receiver to receive a signal from a plurality of satellites. In some examples, a request for a GPS location includes receiving a signal from the plurality of satellites and determining a distance between the device and the plurality of satellites based on a time it takes for the satellites to send a signal. As described herein, the GPS request can utilize a relatively large quantity of computing resources of the device compared to the radio scan at 104. For these reasons the GPS request may be performed when the scan data of the previous scan is different than the scan data of a current scan to avoid performing a GPS request each time a determination of the location of the device is performed.

In some examples, the method 100 determines if a GPS fix is available at 112. In some examples, the device may not be able to perform or execute the GPS location request. For example, the signal may not be received by the satellite when the device is within a building or other structure that interferes with the signal. When the GPS fix is available, the received GPS signals is then calculated locally on the device and a location is determined. In these examples, the location from the GPS location request is stored on a network associated with the device or a database connected to the network associated with the device at 116. In these examples, the location data associated with the device can be stored along with the scan data received by performing the scan at 104.

When the GPS fix is not available, the method 100 can provide scan data to the network at 114. In some examples, the scan data from the scan at 104 is utilized to determine a location within a building or other structure that includes a LAN or WLAN. For example, the scan data is utilized to determine the location of the device based on determined distances between access points of the LAN or WLAN based on the time it takes for a ping to reach an access point or a time it takes for a response to reach the device. In some examples, determining the location of the device based on the scan data takes more computing resources than the scan performed at 104. For this reason, determining the location of the device based on the scan data may be performed when the scan data from a previous scan does not match the scan data from a current scan. In these examples, the location determined based on the scan data is available on a network associated with the device or a database connected to the network associated with the device at 116.

In some examples, the method 100 returns to perform a scan at 104 when the updated location is stored for the device. The method 100 can start again to determine whether the scan data from the first scan associated with the method 100 matches an additional scan to determine if the device has moved from the stored location at 116. In this way, the location of the device is continually stored on the network or database associated with the network to allow the location of the device to be utilized by the device, users of the device, and//or remote users of the device.

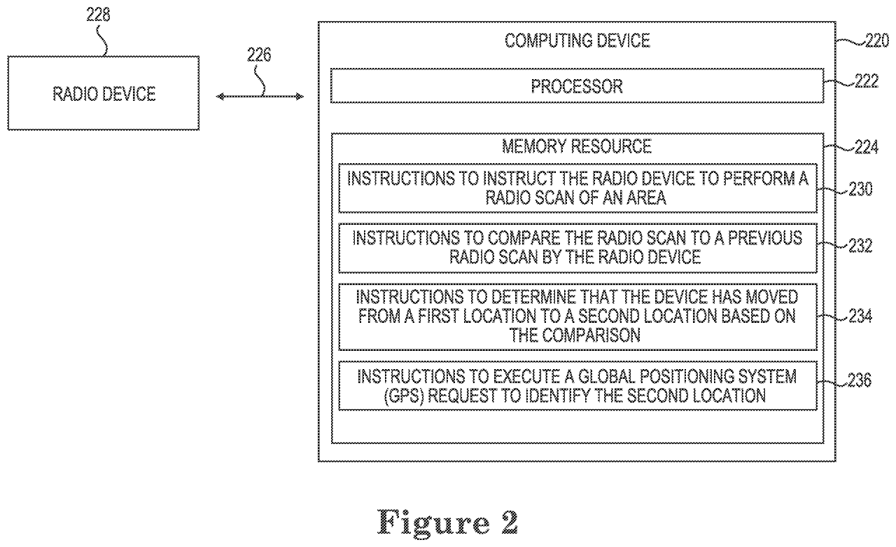

FIG. 2 illustrates an example of a computing device 220 for determining device locations. In some examples, the computing device 220 includes a processor 222 and a memory resource 224 to store instructions that are executed by the processor 222. In some examples, the computing device 220 includes a processor 222 and a memory resource 224 storing instructions 230, 232, 234, 236, that can be executed by the processor 222 to perform particular functions. In some examples, the computing device 220 is communicatively coupled to a radio device 228 through a communication path 226. In some examples, the communication path 226 allows the computing device 220 to send and receive signals (e.g., communication signals, electrical signals, etc.) with the radio device 228.

In some examples, the radio device 228 is capable of performing a scan of devices within the area of the radio device 228. In some examples, the radio device 228 is a cellular or wireless radio that transmits and/or receives wireless signals with other devices. In some examples, the radio device 228 is a cellular device that sends a broadcast to devices within an area and receives a response message from the devices with a corresponding cellular identification of the devices. In other examples, the radio device 228 determines a signal strength between the radio device 228 and the devices within the area. In other examples, the radio device 228 is a network radio that determines a SSID for a plurality of devices connected to a particular network. In these examples, the radio device 228 determines scan data associated with the scan performed by the radio device 228 that can be stored with location information associated with the computing device 220.

The computing device 220 includes instructions 230 stored by the memory resource 224 that is executed by the processor 222 to instruct the radio device 228 to perform a radio scan of an area. As described herein, the radio scan of the area includes sending a broadcast message to a plurality of devices within the are to request information associated with the plurality of devices. For example, the radio scan requests an identification of the plurality of devices that receive the broadcast message. As used herein, a broadcast message and/or a ping broadcast includes a message that is sent to all devices within an area requesting a response message.

The computing device 220 includes instructions 232 stored by the memory resource 224 that is executed by the processor 222 to compare the radio scan to a previous radio scan by the radio device 228. In some examples, comparing the radio scan to a previous radio scan includes comparing a list of devices from the previous radio scan to a current radio scan, comparing a previous list of signal strengths to a current list of signal strengths, and/or comparing a previous list of SSIDs to a current list of SSIDs. For example, the computing device 220 includes instructions to compare a first list of cell identifications associated with the radio scan to a second list of cell identifications associated with the previous radio scan. In some examples, the comparison between the previous radio scan a current radio scan indicates whether the same devices, access points, cellular towers, or wireless devices are within the same area as the computing device 220 as during a previous scan.

The computing device 220 includes instructions 234 stored by the memory resource 224 that is executed by the processor 222 to determine that the device has moved from a first location to a second location based on the comparison. In some examples, the comparison is utilized to determine when there are differences between the devices that were around the computing device 220 during a previous scan and a current scan by the radio device 228. In some examples, a determination is made that the computing device 220 changed locations when there are differences between a first scan and a second scan. For example, when a first list of SSIDs includes an access point that is not on a second list of SSIDs, a determination is made that the computing device 220 moved to a different location. In this example, a different access point may be on the second list of SSIDs, which indicates that the computing device 220 is closer to the different access point than the access point on the first list of SSIDs.

In some examples, a single difference between a first scan and a second scan may not be enough to indicate that the computing device 220 has changed locations. For example, a particular device may be activated during a first scan and deactivated during a second scan. In other examples, the particular device may have responded to the first scan but not responded to the second scan when the particular device is performing other operations. In other examples, the particular device may have responded to the first scan and moved to a different location out of range of the radio device 228 during a second scan when the particular device is a mobile computing device. In these examples, the single difference between a first scan and a second scan may not indicate that the computing device has moved from a first location to a second location.

In some examples, a threshold quantity of differences is utilized to indicate whether the computing device 220 has moved from a first location to a second location. In some examples, a threshold quantity of differences is determined based on a quantity of devices identified by a particular scan. For example, a threshold quantity of differences is based on a percentage of a total quantity of devices identified by a particular scan. In this example, the threshold quantity is 5 devices of 10 devices when the percentage is 50 percent of the total devices. In this example, when 5 or more devices are different between a first scan and a second scan, the computing device 220 is determined to have moved from a first location to a second location. However, when 4 or fewer devices are different between the first scan and the second scan, the computing device is determined to have remained in the same location.

The computing device 220 includes instructions 236 stored by the memory resource 224 that is executed by the processor 222 to execute a global positioning system (GPS) request to identify the second location. In some examples, the different between the radio scan and the previous radio scan exceeds the threshold difference and the GPS request or GPS location request is executed to determine the location of the computing device 220. In other examples, the scan data from the radio scan is utilized to calculate a location of the computing device 220 when the GPS request fails.

As described herein, the GPS request fails when the signal from a satellite is not received by the computing device 220 or radio device 228. In some examples, the location information for the second location is determined through the GPS request and/or a calculation utilizing the radio scan and stored with the radio scan data. In some examples, the computing device 220 includes instructions to provide a result of the GPS request to a network associated with the computing device 220 and the result of the GPS request is stored with properties (e.g., list of device identifications, signal strength, SSIDs, etc.) associated with the radio scan. In this way, the radio scan data and result location for the second location is utilized to compare with future radio scan data to determine when the computing device 220 moves from the second location to a third location before performing an additional location determination (e.g., GPS request, location calculation, etc.).

In some examples, the computing device 220 includes instructions to instruct the radio device 228 to perform an additional radio scan to obtain additional properties to compare to the stored properties associated with the radio scan. In these examples, the computing device 220 includes instructions to determine when the device has changed locations based on the comparison between the additional properties and the stored properties. In this way, the computing device 220 performs the additional scans after a particular time period as described herein.

In some examples, the computing device 220 includes instructions to deactivate the GPS receiver in response to a determination the device has remained at the first location. As described herein, the computing device 220 saves electrical energy (e.g., battery power, etc.) and/or other computing resources by deactivating the GPS receiver and/or GPS radio when the computing device 220 remains at the first location or remains within a threshold distance of the first location.

As described herein, the computing device 220 can include a processor 222 communicatively coupled to a memory resource 224 through a communication path. As used herein, the processor 222 can include, but is not limited to: a central processing unit (CPU), an application specific integrated circuit (ASIC), a field programmable gate array (FPGA), a metal-programmable cell array (MPGA), a semiconductor-based microprocessor, or other combination of circuitry and/or logic to orchestrate execution of instructions 230, 232, 234, 236. In other examples, the computing device can include instructions 230, 232, 234, 236, stored on a machine-readable medium (e.g., memory resource 224, non-transitory computer-readable medium, etc.) and executable by a processor 222. In a specific example, the computing device utilizes a non-transitory computer-readable medium storing instructions 230, 232, 234, 236, that, when executed, cause the processor 222 to perform corresponding functions.

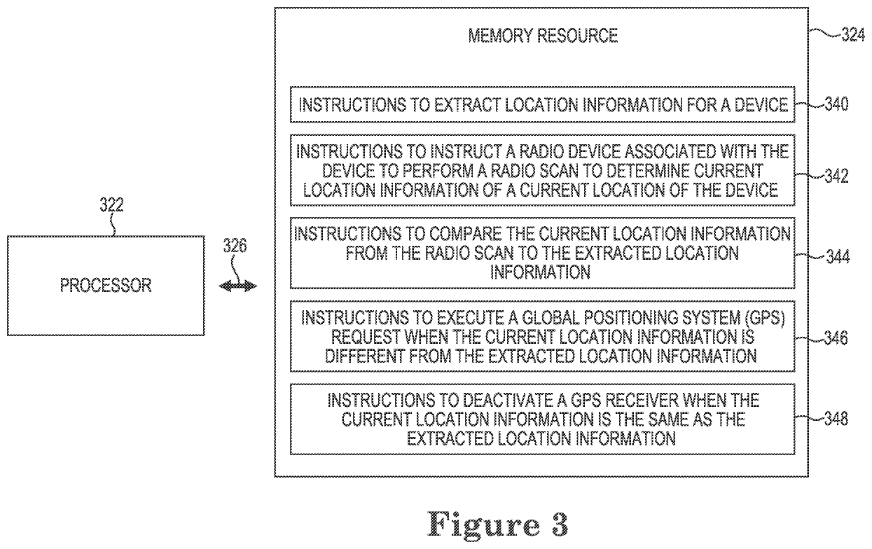

FIG. 3 illustrates an example of a memory resource 324 for determining device locations. In some examples, the memory resource 324 can be a part of a computing device or controller that can be communicatively coupled to a computing system. For example, the memory resource 324 can be part of a computing device 220 as referenced in FIG. 2. In some examples, the memory resource 324 can be communicatively coupled to a processor 322 that can execute instructions 340, 342, 344, 346, 348, stored on the memory resource 324. For example, the memory resource 324 can be communicatively coupled to the processor 322 through a communication path 326. In some examples, a communication path 326 can include a wired or wireless connection that can allow communication between devices and/or components within a single device.

The memory resource 324 may be electronic, magnetic, optical, or other physical storage device that stores executable instructions. Thus, a non-transitory machine-readable medium (MRM) (e.g., a memory resource 324) may be, for example, a non-transitory MRM comprising Random-Access Memory (RAM), read-only memory (ROM), an Electrically-Erasable Programmable ROM (EEPROM), a storage drive, an optical disc, and the like. The non-transitory machine-readable medium (e.g., a memory resource 324) may be disposed within a controller and/or computing device. In this example, the executable instructions 340, 342, 344, 346, 348, can be “installed” on the device. Additionally, and/or alternatively, the non-transitory machine-readable medium (e.g., a memory resource) can be a portable, external, or remote storage medium, for example, that allows a computing system to download the instructions 340, 342, 344, 346, 348, from the portable/external/remote storage medium. In this situation, the executable instructions may be part of an “installation package”.

In some examples, the memory resource 324 can include instructions 340 to extract location information for a device. In some examples, the location information for the device includes a calculated location based on radio scan information and/or a determined location based on a GPS location request. In some examples, the location information also includes radio scan information from a radio scan executed by a radio device. As described herein, the radio scan information includes cellular device identification, signal strength information, and/or SSID information for a plurality of devices within a scan area of the radio device.

In some examples, the memory resource 324 can include instructions 342 to instruct a radio device associated with the device to perform a radio scan to determine current location information of a current location of the device. In some examples, the radio device performs a radio scan by sending a broadcast message or ping to a plurality of devices within a particular range of the radio device. In these examples, the plurality of devices respond to the radio scan with a response packet that includes an identification of a correspond device. In some examples, the responses to the radio scan is compiled to generate radio scan information and/or current location information of the device. In some examples, the scan information includes a list of device identifications, a signal strength between the radio device and the plurality of devices, and/or the SSIDs for the plurality of devices.

In some examples, the memory resource 324 can include instructions 344 to compare the current location information from the radio scan to the extracted location information. In some examples, the current location information includes the information received or determined based on the radio scan performed by the radio device. In these examples, the extracted location information is information received or determined based on a previous radio scan by the radio device. In this way, a list of device identifications from the current location information is compared to the extracted location information. In other examples, the signal strength or SSIDs from the current location information is compared to the extracted location information.

In some examples, the extracted location information includes a cellular identification scan list of cellular towers within an area of the device at a previous time and the current location information includes a cellular identification scan list of cellular towers within an area of device during the radio scan. In these examples, the extracted location information includes a signal strength of the device at the previous time and the current location information includes a signal strength of the device during the radio scan.

In some examples, the memory resource 324 can include instructions 346 to execute a global positioning system (GPS) request when the current location information is different from the extracted location information. As described herein, an activated GPS receiver or GPS radio is activated to perform a location request to determine a location of the device when the current location information is different from the extracted location information. As described herein, a determination that the device has moved from a first location to a second location or that the device has moved a threshold distance away from the first location can be determined based on the comparison. In some examples, the threshold distance from the first location is determined based on whether the device is affected by the change in distance. For example, the threshold distance from the first location includes a distance that would affect or alter a mode of the device.

In some examples, the current location information is compared to the extracted location information to determine if a threshold quantity of differences exist between the extracted location information and the current location information. In some examples, the threshold quantity of differences is a percentage of differences or percentage of similarities between the extracted location information and the current location information. For example, the threshold quantity of differences includes 25 percent threshold difference when only 25 percent of the devices are different between the extracted location information and the current location information.

In a similar way, the comparison can be based on a difference in signal strength between the extracted location information and the current location information. In some examples, the signal strength between the radio device and an access point may not be exactly the same, but may be considered the same when the signal strength of the extracted location information is within a threshold quantity (e.g., threshold RSSI quantity, etc.) of the signal strength of the current location information. In some examples, the threshold quantity is based on a threshold distance of movement that is to trigger a new determination of a location of the device utilizing a more resource intensive GPS request and/or scan information calculation. In some examples, the memory resource 324 includes instructions to store the current location information and GPS information received from the GPS request when the current location information is different from the extracted location information.

In some examples, the memory resource 324 can include instructions 348 to deactivate a GPS receiver when the current location information is the same as the extracted location information. In some examples, the comparison between the extracted location information and the current location information is utilized to determine that the device is in the same location as the extracted location information and/or is within a threshold distance from the location of the extracted location information. In these examples, the location from the extracted location information is utilized as the current location for the device and the GPS receiver is deactivated since a GPS location request is not performed. As described herein, computing resources of the device are saved by deactivating and/or not performing the GPS location request.

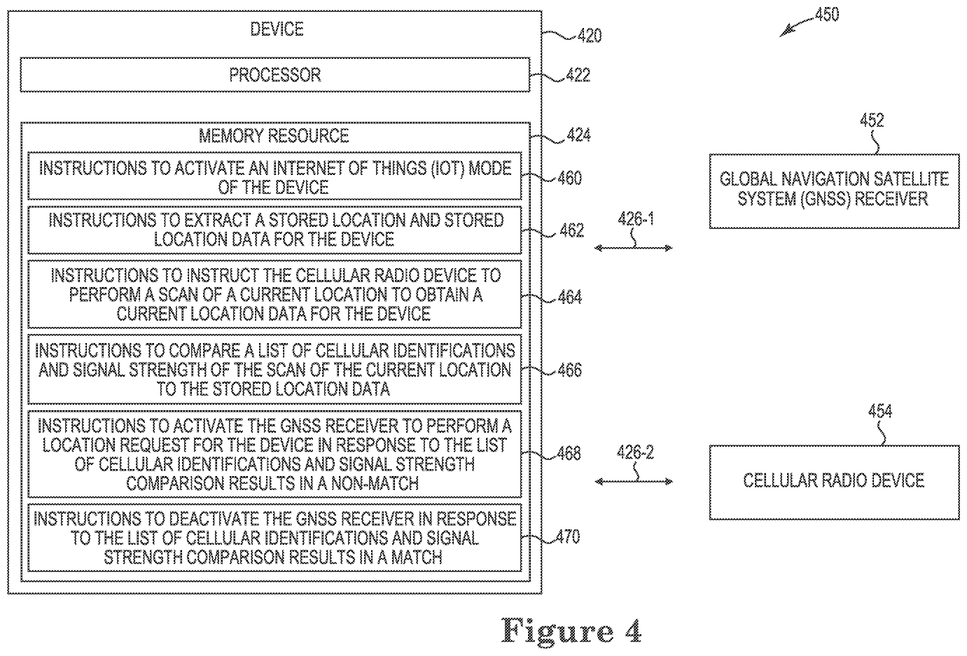

FIG. 4 illustrates an example of a system 450 for determining device locations. In some examples, the system 450 includes a device 420 that includes a processor 422 communicatively coupled to a memory resource 424. In some examples, the device 420 can include a computing device that includes a processor 422 and a memory resource 426 storing instructions 460, 462, 464, 466, 468, 470, that are executed by the processor 422 to perform particular functions.

In some examples, the system 450 includes a global navigation satellite system (GNSS) receiver 452 communicatively coupled through a communication path 426-1. A GNSS receiver 452 includes a satellite location system that is utilized to determine a location of a device based on communication with a satellite or a plurality of satellites. For example, the GNSS receiver 452 is a GPS receiver in specific embodiments. In this example, the GPS receiver is capable of receiving signals from a plurality of satellites and utilizes time of flight or other metrics to determine a distance between the device 420 and the plurality of satellites to determine a location (e.g., physical location, geographic location, geographic coordinate, etc.).

In some examples, the system 450 includes a cellular radio device 454 communicatively coupled through a communication path 426-2. In some examples, the cellular radio device 454 is a device to send and receive cellular signals with other devices that send and receive cellular signals. In some examples, the cellular radio device 454 is capable of sending cellular signal scans or broadcast signals that are utilized to identify a plurality of devices within an area based on responses to the broadcast signals. In this way, other devices that include a cellular radio device capable of receiving the broadcast signal and responding to the broadcast signal.

The device 420 includes instructions 460 stored by the memory resource 426 that can be executed by the processor 422 to activate an Internet of things (IoT) mode of the device 420. As described herein, the device 420 includes multiple modes that allow the device 420 to perform different functions. In some examples, the device 420 includes a user mode that allows a user to provide inputs and view outputs from the device 420. In addition, the device 420 includes an IoT mode that allows the device 420 to operate as an IoT device within an IoT network. In some examples, the device 420 performs function and provides data to the IoT network without inputs from the user of the device 420.

As described herein, the device 420 may be in an IoT mode when it is determined that a user is not utilizing the device 420. For example, the device 420 may switch from the user mode to the IoT mode after a particular time period has passed without a user providing inputs to the device 420. In some examples, the device 420 may limit the use of computing resources during the IoT mode such that the device 420 maintains resources when the device 420 is switched back to the user mode. For example, the device 420 may limit a quantity of battery utilized during the IoT mode to ensure battery is preserved for the user mode.

The device 420 includes instructions 462 stored by the memory resource 426 that can be executed by the processor 422 to extract a stored location and stored location data for the device 420. In some examples, the stored location and stored location data are extracted from a network or database communicatively coupled to the network. In this way, the device 420 is able to access the stored location and stored location data for the device 420 through a network connection. In some examples, the stored location and stored location data for the device 420 includes a previous location determination and location data from a previous cellular scan. In some examples, the stored location is utilized to identify a state of the device 420. As described herein, the state of the device 420 corresponds to particular permissions or functions allowed to be performed by the device 420. Thus, a location assigned to the device 420 is utilized by other applications or hardware of the device 420 that alters the functions or permissions of the device 420.

The device 420 includes instructions 464 stored by the memory resource 426 that can be executed by the processor 422 to instruct the cellular radio device 454 to perform a scan of a current location to obtain a current location data for the device. As described herein, the cellular radio device 454 sends a broadcast signal to scan the area of the current location that is received by a plurality of devices capable of receiving the cellular signal from the cellular radio device 454. In some examples, the plurality of devices provide a response that includes a cellular identification. In other examples, the signal sent and/or received is utilized to determine a signal strength between the cellular radio device 454 and the plurality of devices.

The device 420 includes instructions 466 stored by the memory resource 426 that can be executed by the processor 422 to compare a list of cellular identifications and signal strength of the scan of the current location to the stored location data. As described herein, the scan of the current locations is utilized to generate a list of cellular identifications for devices within the area and a signal strength between the cellular radio device 454 and the plurality of devices. In some examples, the list of cellular identifications and the signal strength are compared to the extracted list of cellular identifications and signal strength independently. In other examples, a threshold percent of differences is utilized between the comparison of both the list of cellular identifications and signal strength. That is, a percentage of the total quantity of cellular identifications and signal strength is utilized to determine if the device 420 has moved from the location of the extracted scan data.

The device 420 includes instructions 468 stored by the memory resource 426 that can be executed by the processor 422 to activate the GNSS receiver 452 to perform a location request for the device 420 in response to the list of cellular identifications and signal strength comparison results in a non-match. As described herein, the comparison between the scan results of a current scan and an extracted location data can result in a non-match, which can indicate that the device 420 has moved from the extracted location.

In some examples, the device 420 includes instructions to determine a scan list of devices associated with a local area network and compare the list of devices associated with the local area network to the stored location data. In these examples, the list of cellular device identifications are compared in addition to the list of devices associated with the local area network. In some examples, the list of devices associated with the local area network includes a list of devices and corresponding SSIDs of the devices.

The device 420 includes instructions 470 stored by the memory resource 426 that can be executed by the processor 422 to deactivate the GNSS receiver 452 in response to the list of cellular identifications and signal strength comparison results in a match. In some examples, the match between the list of cellular identifications and the signal strength indicates that that the device 420 is surrounded by the same or similar devices and a determination is made that the device 420 has not moved over a threshold distance.

As described herein, the threshold distance is a distance where different settings or permissions are applied to the device 420. In some examples, the list of cellular identifications comparison results in a match when a majority of the cellular identifications are in the stored location data. As described herein, the signal strength comparison results in a match when a difference between the signal strength of the scan and a signal strength of the stored location data is within a threshold difference.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure. Further, as used herein, “a” refers to one such thing or more than one such thing.

The figures herein follow a numbering convention in which the first digit corresponds to the drawing figure number and the remaining digits identify an element or component in the drawing. For example, reference numeral 102 may refer to element 102 in FIG. 1 and an analogous element may be identified by reference numeral 302 in FIG. 3. Elements shown in the various figures herein can be added, exchanged, and/or eliminated to provide additional examples of the disclosure. In addition, the proportion and the relative scale of the elements provided in the figures are intended to illustrate the examples of the disclosure, and should not be taken in a limiting sense.

It can be understood that when an element is referred to as being “on,” “connected to”, “coupled to”, or “coupled with” another element, it can be directly on, connected, or coupled with the other element or intervening elements may be present. In contrast, when an object is “directly coupled to” or “directly coupled with” another element it is understood that are no intervening elements (adhesives, screws, other elements) etc.

The above specification, examples, and data provide a description of the system and methods of the disclosure. Since many examples can be made without departing from the spirit and scope of the system and method of the disclosure, this specification merely sets forth some of the many possible example configurations and implementations.

What is claimed is:

1. A device, comprising:
a radio device; and
a processor to:
instruct the radio device to perform a radio scan of an area;
compare the radio scan to a previous radio scan by the radio device;
determine that the device has moved from a first location to a second location based on the comparison; and
execute a global positioning system (GPS) request to identify the second location.

2. The device of claim 1, wherein the processor is to deactivate a GPS receiver in response to a determination the device has remained at the first location.

3. The device of claim 1, wherein the processor is to compare a first list of cell identifications associated with the radio scan to a second list of cell identifications associated with the previous radio scan.

4. The device of claim 1, wherein the processor is to compare a first signal strength associated with the radio scan to a second signal strength associated with the previous radio scan.

5. The device of claim 1, wherein the processor is to provide a result of the GPS request to a network associated with the device.

6. The device of claim 5. wherein the result of the GPS request is stored with properties associated with the radio scan. The device of claim 6, wherein the processor is to:
instruct the radio device to perform an additional radio scan to obtain additional properties to compare to the stored properties associated with the radio scan; and
determine when the device has changed locations based on the comparison between the additional properties and the stored properties.

8. A non-transitory memory resource storing machine-readable instructions stored thereon that, when executed, cause a processor of a computing device to:
extract location information for a device;
instruct a radio device associated with the device to perform a radio scan to determine current location information of a current location of the device;
compare the current location information from the radio scan to the extracted location information;
execute a global positioning system (GPS) request when the current location information is different from the extracted location information; and
deactivate a GPS receiver when the current location information is the same as the extracted location information.

9. The memory resource of claim 8, wherein the extracted location information includes a cellular identification scan list of cellular towers within an area of the device at a previous time and the current location information includes a cellular identification scan list of cellular towers within an area of device during the radio scan.

10. The memory resource of claim 9, wherein the extracted location information includes a signal strength of the device at the previous time and the current location information includes a signal strength of the device during the radio scan.

11. The memory resource of claim 8, wherein the processor is to store the current location information and GPS information received from the GPS request when the current location information is different from the extracted location information.

12. A device, comprising:
a global navigation satellite system (GLASS) receiver;
a cellular radio device; and
a processor to:
activate an internet of things (IoT) mode of the device;
extract a stored location and stored location data for the device;
instruct the cellular radio device to perform a scan of a current location to obtain a current location data for the device;
compare a list of cellular identifications and signal strength of the scan of the current location to the stored location data;
activate the GNSS receiver to perform a location request for the device in response to the list of cellular identifications and signal strength comparison results in a non-match; and
deactivate the GNSS receiver in response to the list of cellular identifications and signal strength comparison results in a match.

13. The device of claim 12, wherein the list of cellular identifications comparison results in a match when a majority of the cellular identifications are in the stored location data.

14. The device of claim 12, wherein the signal strength comparison results in a match when a difference between the signal strength of the scan and a signal strength of the stored location data is within a threshold difference.

15. The device of claim 12, wherein the processor is to:
determine a scan list of devices associated with a local area network; and
compare the list of devices associated with the local area network to the stored location data.
